(19) United States
(12) Patent Application Publication
(10) Pub. No.: US 2022/0128184 A1
(43) Pub. Date: Apr. 28, 2022

(54) Pipe Fitting Replacement Device And Method Of Use

(71) Applicant: Gary Hess, North Charleston, SC (US)

(72) Inventor: Gary Hess, North Charleston, SC (US)

(21) Appl. No.: 17/082,187

(22) Filed: Oct. 28, 2020

(51) Int. Cl. F16L 55/16; F16L 13/14

(52) U.S. Cl. CPC F16L 55/1608; F16L 13/142

(57) ABSTRACT

A pipe fitting replacement device for rapid replacement of a damaged pipe fitting includes a shell, which has a plurality of orifices positioned therein. Each of a plurality of fasteners is engaged to the shell and extends from a respective orifice. The shell is sized and shaped so that the shell is complementary to an existing pipe fitting positioned in a piping network. Each fastener can have inserted therein a respective terminal pipe segment, which results from removal of the existing pipe fitting from the piping network. The fastener sealably engages the respective terminal pipe segment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fitting repair devices and more particularly pertains to a new fitting repair device for rapid replacement of a damaged pipe fitting.

### (2) Description of Related Art Including Information Disclosed Under 37 CFR 1.97 and 1.98

The prior art relates to fitting repair devices. The prior art comprises stab connectors or crimp connections for joining fittings to pipes, as well as patching compounds and methods of use thereof. What is lacking in the prior art is a replacement fitting, which comprises a shell that is complementary to a damaged or leaking fitting. Crimp connections engaged to the shell allow for connection of the shell to terminal pipe segments created by removing the damaged or leaking fitting.

### BRIEF SUMMARY OF THE INVENTION

An embodiment of the disclosure meets the needs presented above by generally comprising a shell, which has a plurality of orifices positioned therein. Each of a plurality of fasteners is engaged to the shell and extends from a respective orifice. The shell is sized and shaped so that the shell is complementary to an existing pipe fitting positioned in a piping network. Each fastener is configured for insertion of and to sealably engage a respective terminal pipe segment, which results from removal of the existing pipe fitting from the piping network.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a pipe fitting replacement device according to an embodiment of the disclosure.

FIG. 2 is a bottom view of an embodiment of the disclosure.

FIG. 3 is a front view of an embodiment of the disclosure.

FIG. 4 is a side view of an embodiment of the disclosure.

FIG. 5 is an in-use view of an embodiment of the disclosure.

FIG. 6 is a flow diagram for a method utilizing an embodiment of the disclosure.

### DETAILED DESCRIPTION OF THE INVENTION

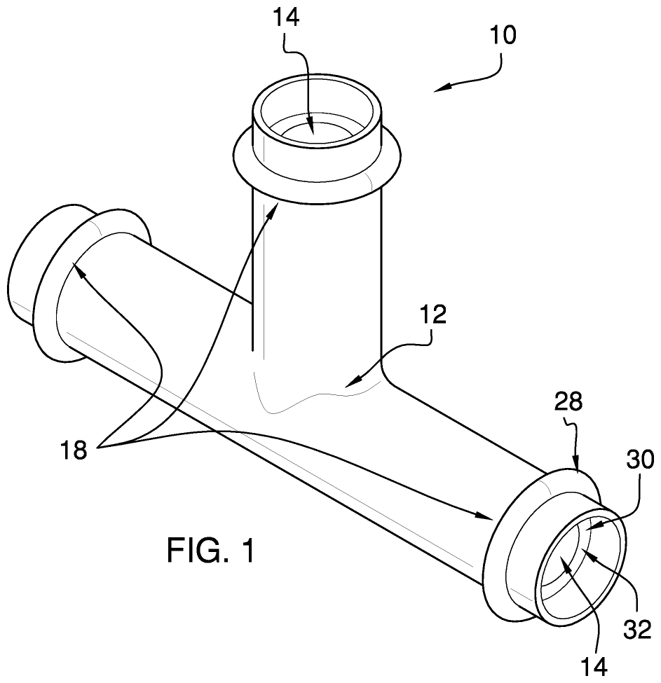

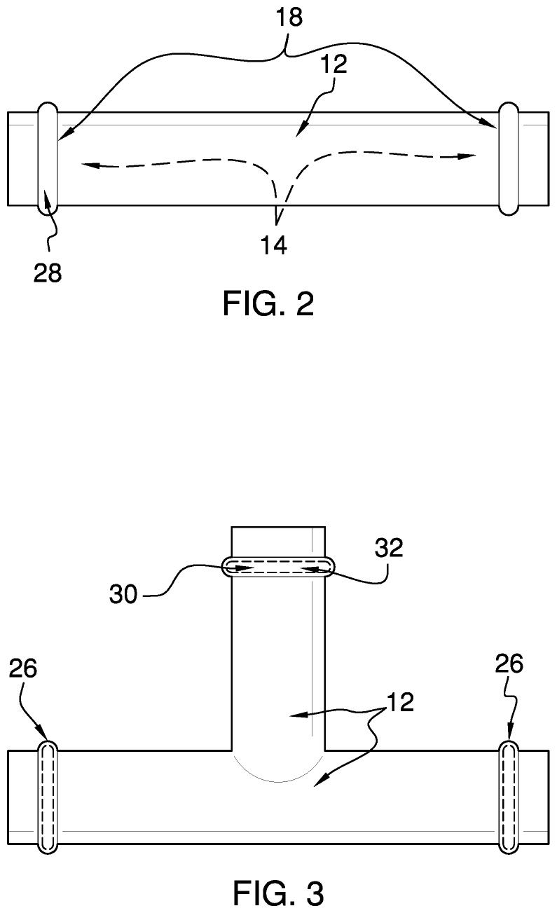

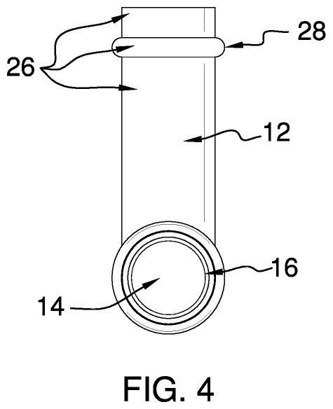

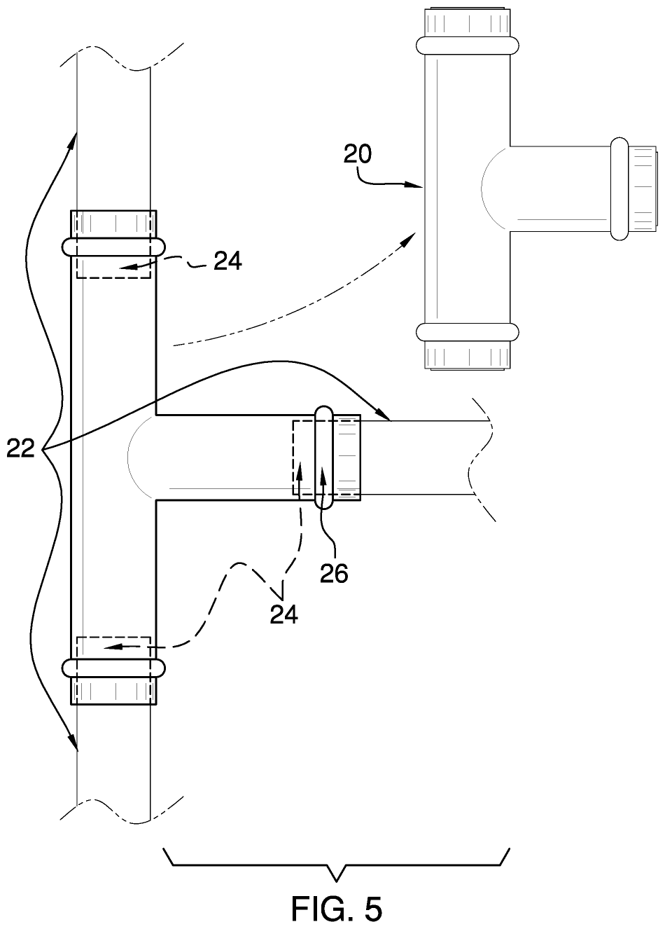

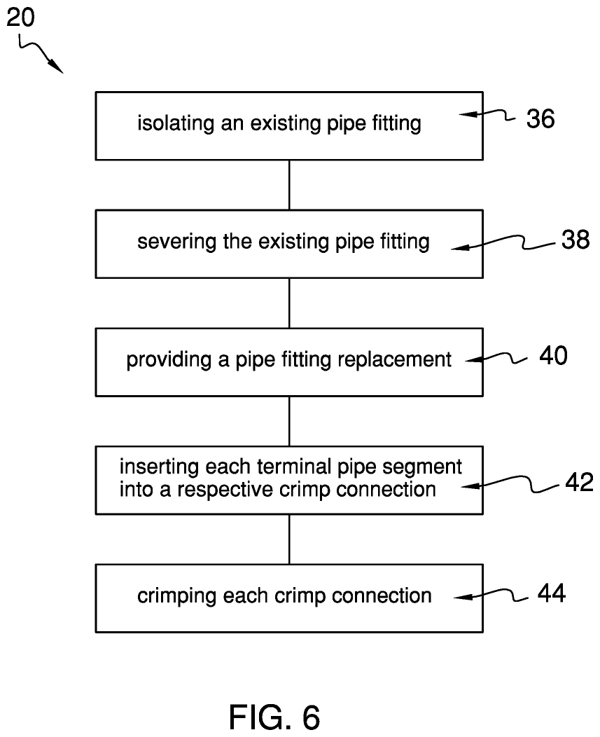

With reference now to the drawings, and in particular to FIGS. 1 through 6 thereof, a new fitting repair device embodying the principles and concepts of an embodiment of the disclosure and generally designated by the reference numeral 10 will be described.

As best illustrated in FIGS. 1 through 6, the pipe fitting replacement device 10 generally comprises a shell 12, which has a plurality of orifices 14 positioned therein. The plurality of orifices 14 comprises from two to six orifices 14. The plurality of orifices 14 may comprise three orifices 14, as shown in FIG. 3. The shell 12 comprises steel, stainless steel, cast iron, black iron, copper, brass, aluminum, polyvinyl chloride, cross-linked polyethylene, or the like. The shell 12 may be linear, arcuate so that the orifices 14 are positioned at 45 degrees, arcuate so that the orifices 14 are positioned at 90 degrees, Y-shaped, T-shaped, as shown in FIG. 3, cross shaped, or the like.

Each orifice 14 has a respective circumference 16 so that the plurality of orifices 14 comprises orifices 14 having a variety of circumferences 16. As will become apparent, when the device 10 has differentially sized orifices 14, it to be utilized in the replacement of reducing and expanding fittings.

Each of a plurality of fasteners 18 is engaged to the shell 12 and extends from a respective orifice 14. The shell 12 is sized and shaped so that the shell 12 is complementary to an existing pipe fitting 20 positioned in a piping network 22. Each fastener 18 is configured for insertion of and to sealably engage a respective terminal pipe segment 24, which results from removal of the existing pipe fitting 20 from the piping network 22. The existing pipe fitting 20 would generally be removed from the piping network 22 by cutting.

The fastener 18 comprises a crimp connection 26, which is configured to be crimped to sealably engage the fastener 18 to the terminal pipe segment 24. The crimp connection 26 comprises stainless steel, carbon steel, copper, or the like.

The crimp connection 26 comprises a flare 28, which is positioned in the fastener 18 and extends radially and outwardly therefrom to define a recess 30 within the fastener 18. The recess 30 has a gasket 32 positioned therein. The flare 28 is configured to be compressed, utilizing a tool well known to those skilled in the art of crimp connectors, so that the gasket 32 forms a seal between the fastener 18 and the terminal pipe segment 24.

In use, the device 10 is configured to replace an existing pipe fitting 20, allowing for a method 34 of replacing an existing pipe fitting 20 in a piping network 22. The method 34, as generally shown in FIG. 7, comprises a first step 36 of isolating an existing pipe fitting 20 in a piping network 22, or terminating flow of a fluid within the piping network 22. The method 34 includes a second step 38 of severing the existing pipe fitting 20 from the piping network 22, therein defining a plurality of terminal pipe segments 24.

A third step 40 of the method 34 entails having a pipe fitting replacement device 10, which has a plurality of orifices 14 numerically equivalent to the plurality of terminal pipe segments 24. A fourth step 42 on the method 34 requires inserting each terminal pipe segment 24 into a respective crimp connection 26. The fifth and final step 44 of the method 34 entails crimping each crimp connection 26 to sealably engage the crimp connections 26 to the terminal pipe segments 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A pipe fitting replacement device comprising:
a shell having a plurality of orifices positioned therein; and
a plurality of fasteners, each fastener being engaged to the shell and extending from a respective orifice, the shell being sized and shaped such that the shell is complementary to an existing pipe fitting positioned in a piping network, wherein each fastener is configured for insertion of and for sealably engaging a respective terminal pipe segment resulting from removal of the existing pipe fitting from the piping network.

2. The pipe fitting replacement device of claim 1, wherein the plurality of orifices comprises from two to six orifices.

3. The pipe fitting replacement device of claim 2, wherein the plurality of orifices comprises three orifices.

4. The pipe fitting replacement device of claim 1, wherein the shell comprises steel, stainless steel, cast iron, black iron, copper, brass, aluminum, polyvinyl chloride, or cross-linked polyethylene.

5. The pipe fitting replacement device of claim 1, wherein the shell is linear, arcuate such that the orifices are at 45 degrees, arcuate such that the orifices are at 90 degrees, Y-shaped, T-shaped, or cross shaped.

6. The pipe fitting replacement device of claim 1, wherein each orifice has a respective circumference such that the plurality of orifices comprises orifices having a variety of circumferences

7. The pipe fitting replacement device of claim 1, wherein the fastener comprises a crimp connection, wherein the crimp connection is configured for crimping for sealably engaging the fastener to the terminal pipe segment.

8. The pipe fitting replacement device of claim 7, wherein the crimp connection comprises stainless steel, carbon steel, or copper.

9. The pipe fitting replacement device of claim 7, wherein the crimp connection comprises a flare positioned in the fastener and extending radially and outwardly therefrom defining a recess within the fastener, the recess having a gasket positioned therein, wherein the flare is configured for compressing such that the gasket forms a seal between the fastener and the terminal pipe segment.

10. A method of replacing an existing pipe fitting in a piping network, the method comprising the steps of:
isolating an existing pipe fitting in a piping network or terminating flow of a fluid within the piping network;
severing the existing pipe fitting from the piping network, therein defining a plurality of terminal pipe segments;
providing a pipe fitting replacement device comprising:
a shell having a plurality of orifices positioned therein, the shell being sized and shaped such that the shell is complementary to the existing pipe fitting, and
a plurality of crimp connections, each crimp connection being engaged to the shell and extending from a respective orifice;
inserting each terminal pipe segment into a respective crimp connection; and
crimping each crimp connection for sealably engaging the crimp connections to the terminal pipe segments.

11. A pipe fitting replacement device comprising:
a shell having a plurality of orifices positioned therein, the plurality of orifices comprising from two to six orifices, the plurality of orifices comprising three orifices, the shell comprising steel, stainless steel, cast iron, black iron, copper, brass, aluminum, polyvinyl chloride, or cross-linked polyethylene, the shell being linear, arcuate such that the orifices are at 45 degrees, arcuate such that the orifices are at 90 degrees, Y-shaped, T-shaped, or cross shaped, each orifice having a respective circumference such that the plurality of orifices comprises orifices having a variety of circumferences; and
a plurality of fasteners, each fastener being engaged to the shell and extending from a respective orifice, the shell being sized and shaped such that the shell is complementary to an existing pipe fitting positioned in a piping network, wherein each fastener is configured for insertion of and for sealably engaging a respective terminal pipe segment resulting from removal of the existing pipe fitting from the piping network, the fastener comprising a crimp connection, wherein the crimp connection is configured for crimping for sealably engaging the fastener to the terminal pipe segment, the crimp connection comprising stainless steel, carbon steel, or copper, the crimp connection comprising a flare positioned in the fastener and extending radially and outwardly therefrom defining a recess within the fastener, the recess having a gasket positioned therein, wherein the flare is configured for compressing such that the gasket forms a seal between the fastener and the terminal pipe segment.
